(19) United States
(12) Patent Application Publication
(10) Pub. No.: US 2026/0022818 A1
(43) Pub. Date: Jan. 22, 2026

(54) OPTIC FOR CREATING ASYMMETRICAL LIGHT DISTRIBUTION AND LIGHT FIXTURES INCLUDING SAME

(71) Applicant: ABL IP Holding LLC, Atlanta, GA (US)

(72) Inventors: Jie Chen, Decatur, GA (US); Qi Ai, Peachtree City, GA (US); Melissa N. Ricketts, Conyers, GA (US); Craig Eugene Marquardt, Covington, GA (US); Jeffrey Chase Carpenter, Atlanta, GA (US); Travis Middleton, Atlanta, GA (US); Matthew Scott Hoch, McDonough, GA (US)

(21) Appl. No.: 18/778,573

(22) Filed: Jul. 19, 2024

(51) Int. Cl. F21V 7/00; F21V 29/70; F21Y 105/10

(52) U.S. Cl. CPC F21V 7/0091; F21V 29/70; F21Y 2105/10

(57) ABSTRACT

An optic sheet having incorporated within the light entrance surface of the optic sheet optical features for creating an asymmetric light distribution from light fixtures in which the optic sheet is incorporated. In some embodiments, the optical features include total internal reflection portions and refractor portions that are provided in rows across the optic sheet and that alternate along the length of the optic sheet. In some uses, the optic sheet is designed to redirect light emitted in an undesirable (first) direction UD toward a desirable (second) direction DD.

### FIELD OF INVENTION

The present technology relates to light fixtures and more particularly to optics for light fixtures that include total internal reflection refractors to control the directionality of light emitted from the light fixtures.

### DESCRIPTION OF THE RELATED ART

Outdoor light fixtures are used in residential and commercial locations and may be used for various illumination purposes, including illuminating streets, sidewalks, and parking lots. Outdoor light fixtures are often desirable because they provide illumination at night to thereby increase visibility and safety.

It may be desirable in some situations to control the directionality of the light emitted by a fixture. For example, it might be desirable to control the light emitted by outdoor light fixtures such that the emitted light is directed towards a sidewalk and/or street but not towards residences located behind the light fixtures, which can be a nuisance to the inhabitants.

In the case of gas stations having a store 10 and/or canopy 20 covering the gas pumps 30, it may be desirable for some of the light fixtures installed in the canopy 20 to have a symmetrical Lambertian distribution to emit light downwardly to light the general area under the canopy (see FIG. 1, light fixtures 40). However, it may also be desirable for other of the light fixtures (see FIG. 1, light fixtures 50) provided around the periphery of the store 10 and/or canopy 20 to emit an asymmetrical light distribution to light the area surrounding the store 10 and/or canopy 20 (such as the forecourt area 60 between the canopy 20 and the store 10).

Large external reflectors positioned adjacent the light fixtures, or the light sources in the light fixtures, have been used to redirect emitted light in the desired direction. Moreover, small internal reflectors have been positioned within the primary optic. Both of these solutions lower the overall optical efficiency of the fixture and increase cost and installation time. Accordingly, there is a need to better and more accurately control the direction of light emitted by the light fixtures without increasing the cost of such fixtures.

### BRIEF SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Embodiments of the present invention provide optic sheets that create asymmetrical light distributions as well as light fixtures that incorporate such optic sheets.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a schematic layout of a gas station.

FIG. 2 is a top perspective view of an embodiment of an optic sheet for a light fixture.

FIG. 3 is a bottom perspective view of the optic sheet of FIG. 2.

FIG. 4 is a cross-section of the optic sheet of FIG. 1 taken along line 4-4 in FIG. 2.

FIG. 5 is an enlarged section view taken at inset circle 5 in FIG. 4.

FIG. 6 is a top plan view of the optic sheet of FIG. 2.

FIG. 7 is a bottom plan view of the optic sheet of FIG. 2.

FIG. 8 is a left side elevation view of the optic sheet of FIG. 2.

FIG. 9 is a right side elevation view of the optic sheet of FIG. 2.

FIG. 10 is a front end view of the optic sheet of FIG. 2.

FIG. 11 is a rear end view of the optic sheet of FIG. 2.

FIG. 12 is a top perspective view of another embodiment of an optic sheet for a light fixture.

FIG. 13 is a schematic 2D ray trace diagram illustrating light rays passing through a portion of the optic sheet of FIG. 2.

FIG. 14 is a polar plot showing the distribution of light created when a light source emits light that is redirected by the optic sheet of FIG. 2.

FIG. 15 is a bottom perspective view of an embodiment of a light fixture with the optic sheet of FIG. 2, where the light fixture is installed in a canopy ceiling.

FIG. 16 is an exploded view of the light fixture of FIG. 15.

FIG. 17 is a cross-sectional perspective view of the light fixture of FIG. 15.

FIG. 18 is a cross-sectional view of the light fixture of FIG. 15.

FIG. 19 is an enlarged cross-sectional view from FIG. 18.

FIG. 20 is an exploded view of an embodiment of a compression ring used in the light fixture of FIG. 15.

FIG. 21 is a top perspective view of the compression ring of FIG. 20.

FIG. 22 is a top plan view of the compression ring of FIG. 20.

FIG. 23 is an exploded view of an embodiment of a light emitting module used in the light fixture of FIG. 15.

FIG. 24 is a top perspective view of a printed circuit board populated with rows of light emitting diodes.

FIG. 25 is a top perspective view of another embodiment of an optic sheet for a light fixture.

### DETAILED DESCRIPTION

Throughout this description for the purposes of explanation, numerous specific details are set forth in order to provide a thorough understanding of the many aspects and embodiments disclosed herein. It will be apparent, however, to one skilled in the art that the many aspects and embodiments may be practiced without some of these specific details. In other instances, known structures and devices are shown in diagram or schematic form to avoid obscuring the underlying principles of the described aspects and embodiments.

Embodiments of the present invention are directed to an optic sheet having incorporated within it optical features for creating an asymmetric light distribution from light fixtures in which the optic sheet is incorporated. In some uses, the optic sheet is designed to redirect light emitted in an undesirable direction UD toward a desirable direction DD.

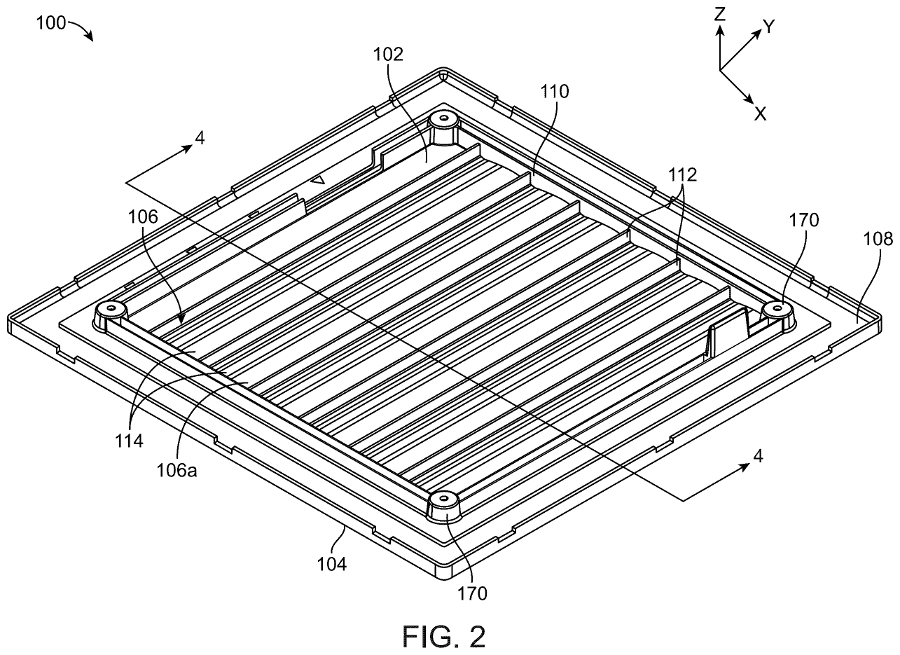

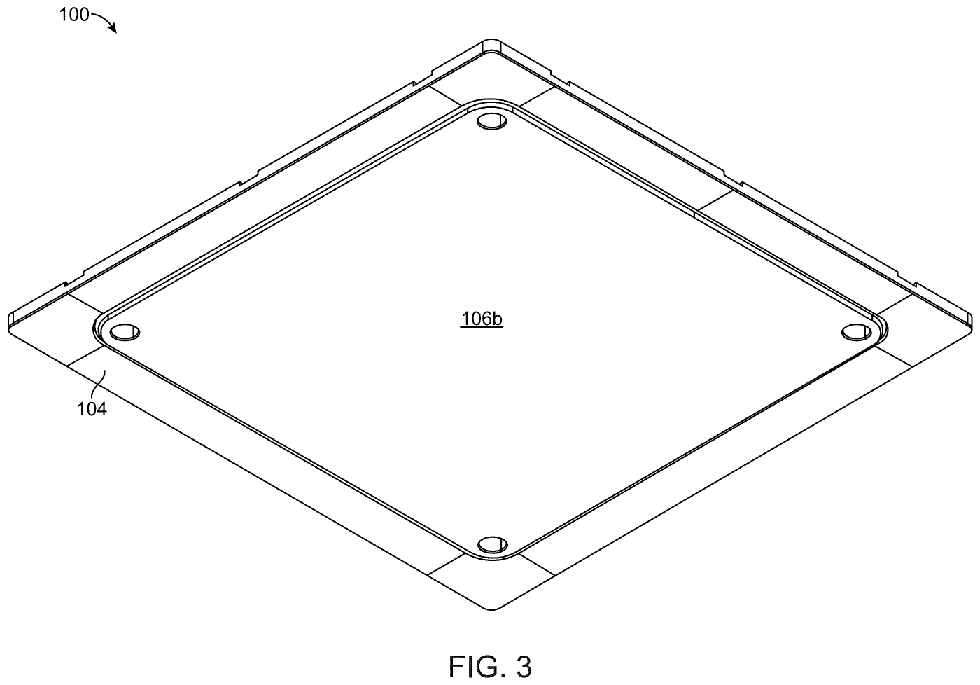

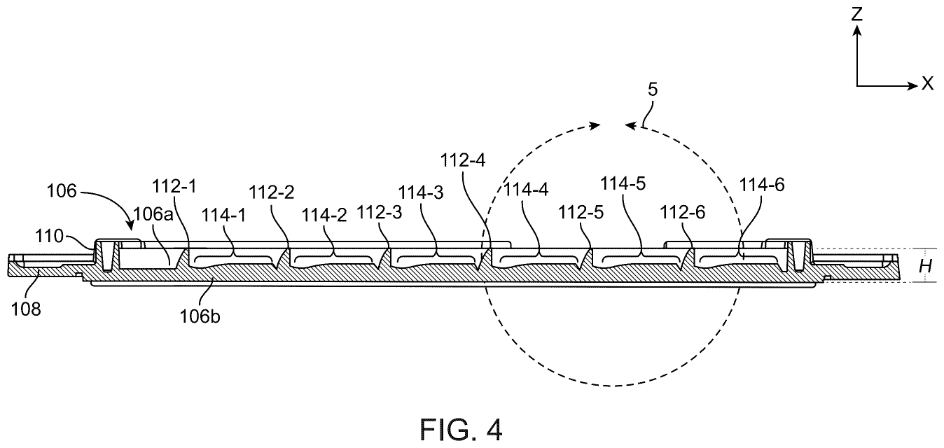

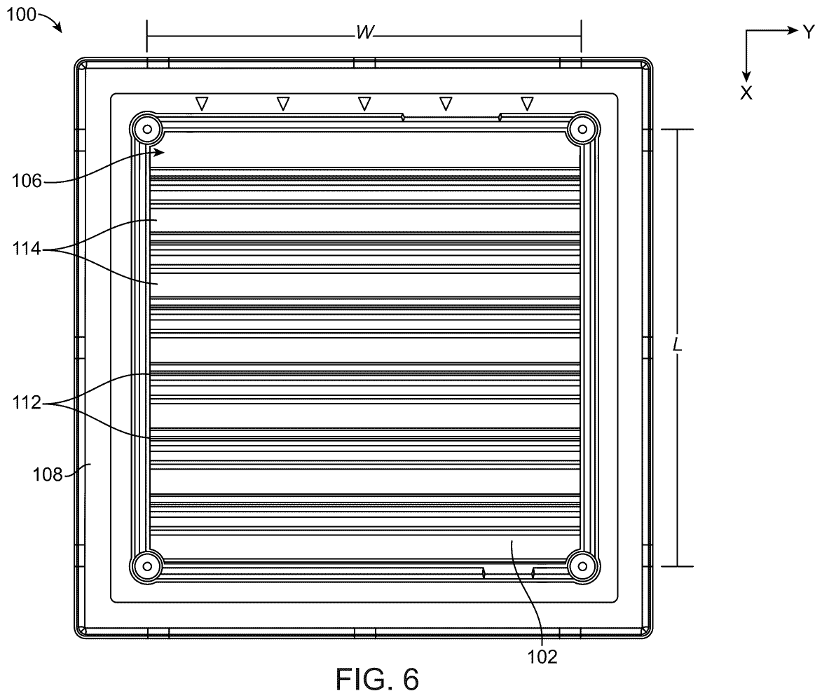

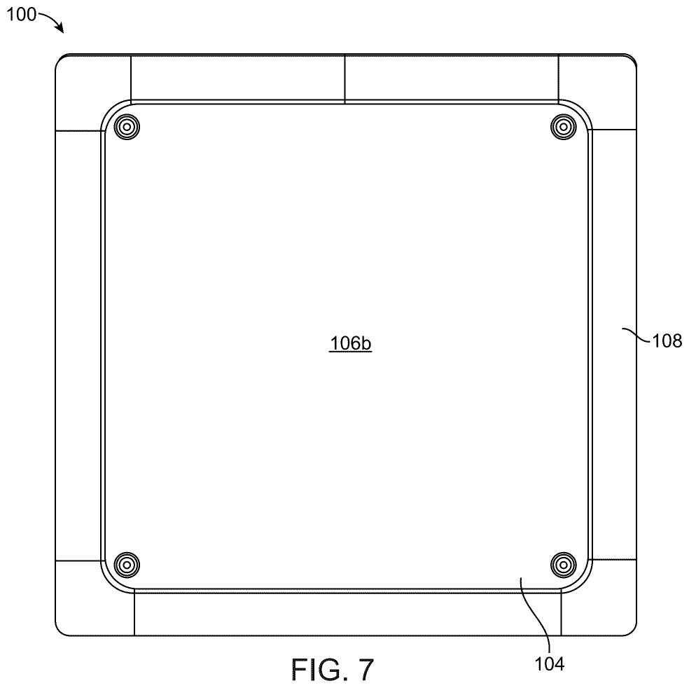

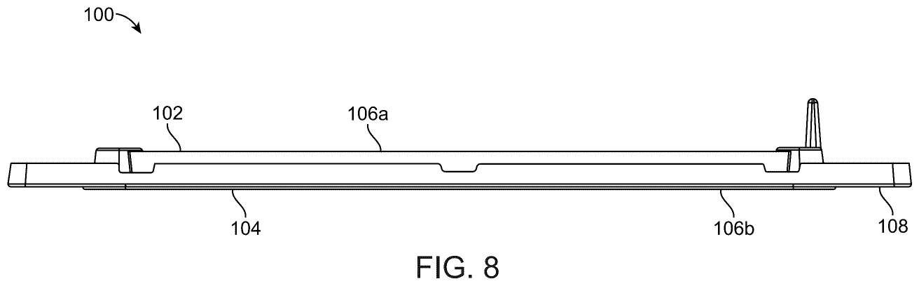

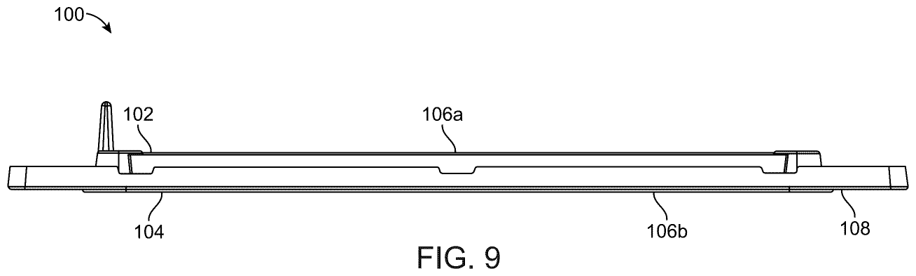

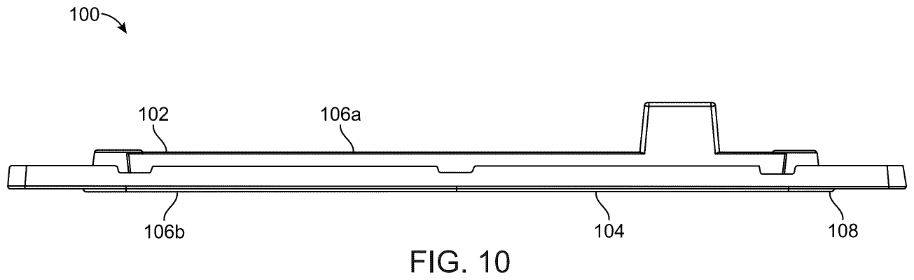

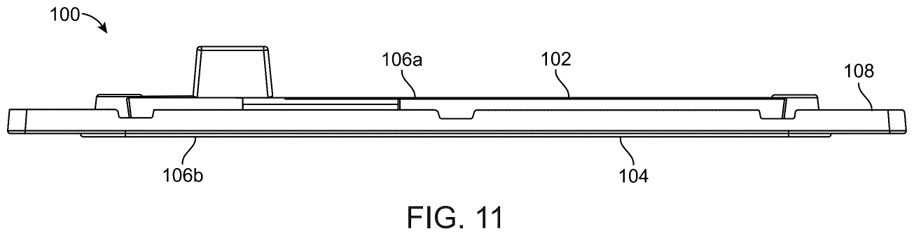

FIGS. 2-11 show one embodiment of an optic sheet 100, which extends in a plane containing axes x and y and that includes an upper surface 102 and a lower surface 104. The optic sheet 100 includes an optical area 106 that interacts with light and a mounting portion 108 that extends around the perimeter of the optical area 106. The mounting portion 108 is used to mount the optic sheet 100 to a light fixture. The optical area 106 includes a light entrance surface 106a that receives light emitted by the light sources of the light fixture and an opposing light exit surface 106b that emits light from the light fixture. In some embodiments, the light exit surface 106b (and optionally the entire lower surface 104 of the optic sheet 100) is substantially or entirely smooth. In other embodiments, surface enhancements may be provided on the light exit surface 106b (and optionally the lower surface 104 of the optic sheet 100).

In some embodiments, a wall 110 extends upwardly between the optical area 106 and the mounting portion 108 to create a partial or entire divide between the optical area 106 and the mounting portion 108. Such a wall 110 can serve to seal the optical area 106 and register the optic sheet 100 during installation.

The optical area 106 of the optic sheet 100 has a length L measured along an axis x, a width W is measured along an axis y, and a height H is measured along an axis z. The optic sheet 100 extends in a plane containing axes x and y. The optic sheet 100 (and optical area 106) is illustrated as having a square shape, but may be formed of other shapes. Moreover, the optic sheet 100 and optical area 106 may assume different shapes in some embodiments (e.g., the optic sheet 100 may be square but the optical area 106 within the optic sheet 100 may be circular).

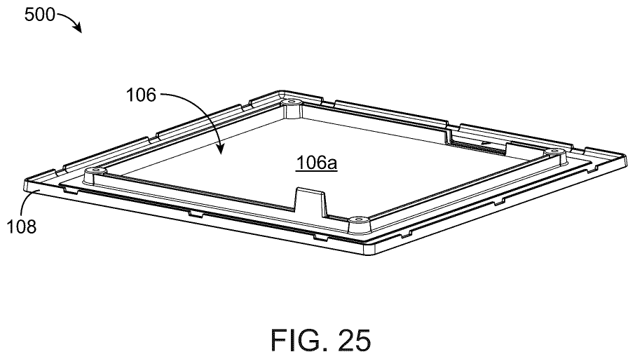

In applications where asymmetric light emission is desired, optical features are formed in the light entrance surface 106a of the optical area 106 and include a plurality of a total internal reflection (“TIR”) refractor portions (hereinafter, “TIR portions 112”) and a plurality of refractor portions 114, as explained in further detail below. In some embodiments, the TIR portions 112 and the refractor portions 114 are formed integrally within the optic sheet 100, such as via molding (e.g., injection molding). In applications where substantially symmetrical light emission is desired, the light entrance surface 106a may be devoid of optical structures that bend or otherwise manipulate the light. For example, FIG. 25 illustrates an optic sheet 500 with a substantially smooth light entrance surface 106a and light exit surface 106b such that light emitted by optic sheet 500 has a generally symmetrical distribution. However, surface enhancements may be provided on either or both of surfaces 106a, 106b to alter the appearance of the emitted light. However, the overall light emission from the optic sheet 500 remains symmetrical.

The optic sheet 100 can be formed as a solid monolithic optical body of any optical grade polymeric material, including, but not limited to, silicone, poly (methyl methacrylate) (PMMA), polycarbonate, acrylics, glass, etc. However, in other embodiments, the optical area 106 and mounting portion 108 are formed separately, either of the same or of different materials. For example, the mounting portion 106 may be formed of metal (e.g., aluminum, steel, etc.) and serve as a frame or bezel to support the optical area 106 (formed of, for example, silicone, PMMA, acrylic, glass, etc.).

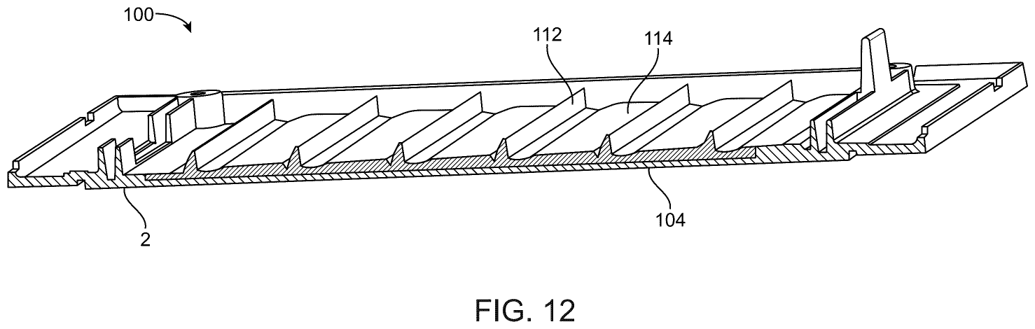

In other embodiments, the optical sheet 100 may be formed of one or more layers. The layers may be formed separately and subsequently attached to each other. Alternatively, one or more of the layers may be molded directly onto another layer. For example, traditional polymeric optical materials (e.g., polycarbonate and PMMA materials) are not as tolerant to heat as silicone and thus can degrade over time when subjected to elevated temperatures. Thus, in some embodiments, the optic sheet 100 may be formed to capitalize on the benefits of different materials while mitigating the drawbacks of those materials. For example and as shown in FIG. 12, the optic sheet 100 may be formed by providing a base or substrate 2 made from a first material (e.g., a polycarbonate or PMMA material) that in situ will form the lower surface 104 of the optic sheet 100 most distal the heat generating light sources. The optical features (e.g., TIR portions 112 and refractor portions 114) may be formed of silicone and provided on the upper surface of the substrate 2, either by separately forming such features and subsequently attaching them to the upper surface of the substrate 2 or molding them directly on the upper surface of the substrate 2. In other embodiments, the substrate 2 and the optical features may be co-molded. Regardless, the substrate 2 imparts integrity to the optic sheet 100 but is distanced from the heat generated by the light sources. Rather, the more thermally resistant silicone material forming the optical features is located more proximate the light sources and serves to insulate the substrate from heat generated by the light sources.

In some embodiments, the TIR portions 112 and the refractor portions 114 each extend linearly in rows across some or the entirety of the width W of the optical area 106 and/or alternate along the length L of the optical area 106. In the embodiment illustrated in FIGS. 2-11, the optical area 106 includes six TIR portions (labeled 112-1 to 112-6) and six refractor portions (labeled 114-1 to 114-6). Each refractor portion 114-1 to 114-6 is adjacent a TIR portion (one of 112-1 to 112-6). However, any number and arrangement of TIR portions 112 and refractor portions 114 may be used. Moreover, while in the illustrated embodiments the geometry of each of the TIR portions 112-1 to 112-6 and each of the refractor portions 114-1 and 114-6 are identical, in some embodiments the TIR portions 112 will have different geometries from other TIR portions 112 and/or the refractor portions 114 will have different geometries from other refractor portions 114.

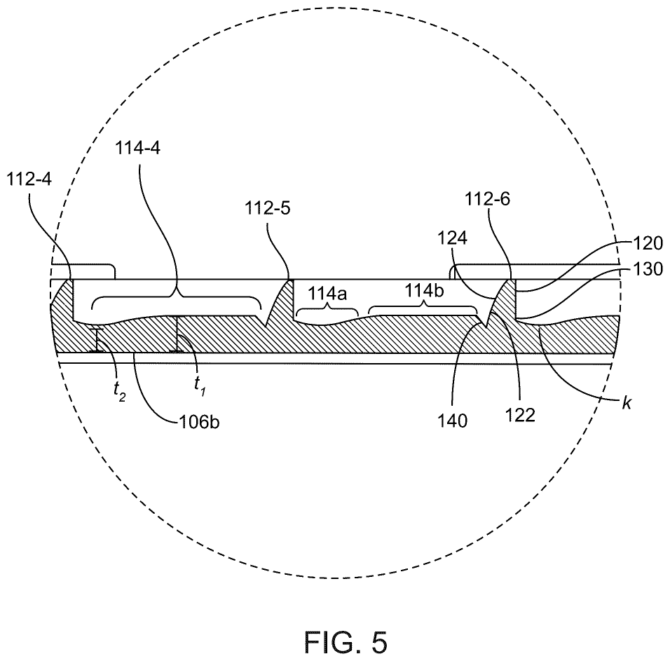

As best seen in FIG. 5, the TIR portions 112 include an upstanding front wall 120 that refracts incident light towards the total internal reflection surface 122 of a curved back wall 124 that curves outwardly (convexly) relative to the front wall 120. In the illustrated embodiment, the front wall 120 has a substantially flat exterior surface on which light is incident, but such may not always be the case. While the front wall 120 and the back wall 124 may intersect each other directly, in some embodiments their distal ends are connected with one or more connecting walls 121, which in some embodiments are driven by manufacturing considerations but do not impact the optical performance of optic sheet 100. In some embodiments, the front wall 120 extends in a plane that is substantially perpendicular (within +/−5°) relative to the plane of the optic sheet 100. However, the angulation and/or curvature of the surfaces (front wall 120 and back wall 124) may be modified to achieve a particular light output. Thus, the geometry of these surface shown in the figures are not limiting on embodiments of the present invention.

The refractor portion 114 is provided directly adjacent the base 130 of the front wall 120 of the TIR portion 112. The refractor portion 114 includes a first refractor portion 114a and a second refractor portion 114b. The first refractor portion 114a is formed of a curved surface 116 that first curves downwardly (convexly) relative to and immediately proximate the base 130 of the front wall 120 of the TIR portion 112 and then curves upwardly to transition from the first refractor portion 114a into the second refractor portion 114b. In this way, the first refractor portion 114a forms a curved trough across the width W of the optical area 106. The curvature of the curved surface 116 may be adjusted depending on the desired distribution.

The first refractor portion 114a transitions into the second refractor portion 114b. The second refractor portion 104b is substantially linear and/or flat in cross-section and in some embodiments includes a portion that extends substantially parallel to the plane of the optic sheet 100. In some embodiments, the second refractor portion 114b has a thickness t₁ greater than a thickness t₂ of the first refractor portion 114a at a lowermost point k. In some embodiments, thickness t₁ of the second refractor portion 114b is greater than thickness t₂ at any location of the first refractor portion 114a.

Moving along the length L of the optical area 106, another TIR portion (e.g., 112-6) is provided adjacent refractor portion (e.g., 114-5) and more specifically adjacent the end of the second refractor portion 114b most distal from TIR portion 112-5. In some embodiments, a notch 140 extending downwardly in a direction towards the light exit surface 106b is interposed between the second refractor portions 114b and TIR portions 112. The notch 140 serves to extend the length of the curved back wall 124 (and consequently the length of the total internal reflection surface 122 of the back wall 124) of the TIR portions 112 such that the total internal reflection surface 122 may redirect more light. A notch 140 may be, but does not have to be, interposed between adjacent refractor portions 114 and TIR portions 112.

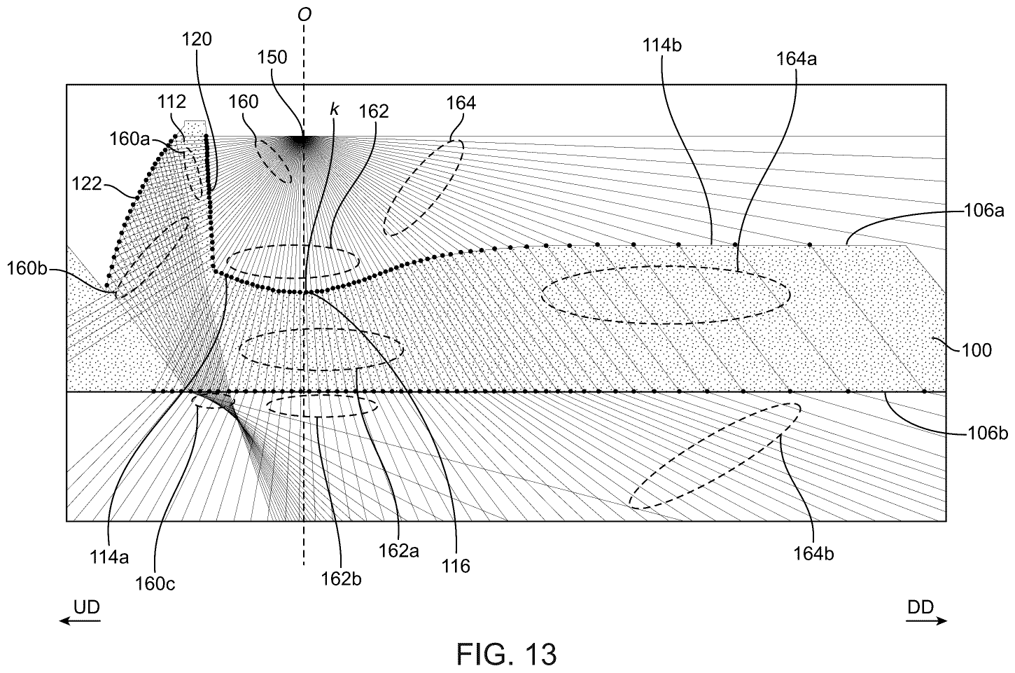

In use, the optic sheet 100 is positioned over, and a distance from, one or more light sources to direct the light emitted by the light sources that passes through the optic sheet 100 (and more specifically through the optical area 106 of the optic sheet 100). The optic sheet 100 is oriented such that the upper surface 102 faces the light sources. In some embodiments, the light sources are provided in rows, and the optic sheet 100 is positioned such that the rows of TIR portions 112 and refractor portions 114 extend substantially parallel to the light sources. In some embodiments, the optic sheet 100 is positioned relative to the light sources such that the optical axis O of the light sources are substantially aligned with a lowermost point k of the first refractor portion 114a (as shown in FIG. 13). As a general rule, the optical axis O may be offset from the lowermost point k of the first refractor portion 114a (either toward or away from the TIR portion 112 along axis x) by a cross-wise dimension of the light source (e.g., LED) without significantly impacting the light distribution from the optic sheet 100.

In some embodiments, the refractor portions 114 refract the emitted light such that the majority of emitted light passing through the refractor portions 114 is directed in the desirable direction DD, and the TIR portions 112 redirect and reflect some of the light that is emitted in an undesirable direction (UD) back in the desirable direction DD. In some embodiments, the divide between the desirable direction DD and the undesirable direction UD within a row of light sources(s) is the optical axis O of the light source(s).

FIG. 13 is a ray trace diagram illustrating performance of optic sheet 100. First light rays 160 are generally emitted from a light source 150 toward the undesirable direction UD and are reflected and refracted by the TIR portion 112 so as to leave the optical area 106 of the optic sheet 100 in a direction toward the desirable direction DD. In some embodiments, the first light rays 160 are incident on the outer surface of the front wall 120 and refracted as refracted first light rays 160a into the TIR portion 112 at an entrance bending angle. For purposes of this application, “bending angle” refers to the angle between the paths of a light ray entering and exiting an optic surface. The entrance bending angle of at least some of the first light rays 160 refracts them as refracted first light rays 160a towards the total internal reflection surface 122. In some embodiments, the entrance bending angle range of at least some of the first light rays 160 (in this case, the angle between the path of a first light ray 160 and a refracted first light ray 160a) is between 1°-30°, inclusive; between 5°-30°, inclusive; 10°-30°, inclusive; 15°-30°, inclusive; between 20°-30°, inclusive; and/or between 20°-25°, inclusive.

The majority of the refracted first light rays 160a are reflected as reflected first light rays 160b by the total internal reflection surface 122 toward the desirable direction DD. The reflected first light rays 160b are then refracted by the light exit surface 106b and exit the optical area 106 of the optic sheet 100 as output first light rays 160c in a direction toward the desirable direction DD. The output first light rays 160c leave the light exit surface 106b at angles between 0° and 90°, inclusive; between 0° and 85°, inclusive; between 0° and 80°, inclusive; and/or between 0° and 75°, inclusive, relative to nadir.

Second light rays 162 pass through the first refractor portion 114a, such that the curved surface 116 refracts the second light rays 162 as refracted second light rays 162a and the light exit surface 106b refracts the refracted second light rays 162a such that they exit as output second light rays 162b. As can be seen in FIG. 13, while refraction is occurring at curved surface 116 and light exit surface 106b, the second light rays 162 leave the optic sheet 100 in the same general direction that they entered the optic sheet 100 (i.e., if a second light ray 162 enters the first refractor portion 114a in the undesirable direction UD, it exits the first refractor portion 114a in the undesirable direction UD and if a second light ray 162 enters the first refractor portion 114a in the desirable direction DD, it exits the first refractor portion 114a in the desirable direction DD). In this way, some light may be emitted in the undesirable direction.

Third light rays 164 pass through second refractor portion 114b and leave the optic sheet 100 in the desirable direction DD. The third light rays 164 are incident on the second refractor portion 114b at the light entrance surface 106a, which refracts the third light rays 164 downwardly into the second refractor portion 114b at an entrance bending angle to form refracted third light rays 164a. Upon passing out of the second refractor portion 114b through light exit surface 106b, the refracted third light rays 164a are again refracted at an exit bending angle to form output third light rays 164b that exit the optic sheet 100 in the desirable direction DD. In some embodiments, the entrance angle of the third light rays 164 (the angle measured from nadir at which third light rays 164 enter second refractor portion 114b) is greater than the exit angle of the output third light rays 164b (the angle measured from nadir at which output third light rays 164b exit second refractor portion 114b). In this way, second refractor portion 114b serves to reduce the angle of the emitted light. In some embodiments, output third light rays 164b exit optic sheet 100 at an exit angle between 0° and 90°, inclusive; between 0° and 85°, inclusive; between 0° and 80°, inclusive; and/or between 0° and 75°, inclusive, relative to nadir. In some embodiments, the exit angle of all or substantially all of the output third light rays 164b is less than 85°, less than 80°, and/or less than 75° relative to nadir. In some embodiments, the majority of output third light rays 164b exit optic sheet 100 at an exit angle between 20° and 80°, inclusive; and/or between 30° and 75°, inclusive, relative to nadir.

In some embodiments, all or substantially all of the light emitted by the optic sheet 100 in the desirable direction (e.g., output first light rays 160c, output second light rays 162b, and output third light rays 164b in the embodiment of FIG. 13), is emitted in the desirable direction at an exit angle greater or equal to 0° and less than or equal to 80°, 75°, and/or 70° relative to nadir. In some embodiments, no light is emitted from the optic sheet 100 in the desirable direction at an angle relative to nadir that is greater than 80°, 75°, 72°, and/or 70° (i.e., all light emitted from the optic sheet 100 in the desirable direction is at an angle relative to nadir that is less than or equal to 80°, 75°, 72°, and/or) 70°.

As seen in FIG. 13, the majority of light rays are emitted by the optic sheet 100 toward the desirable direction DD and thus the optic sheet creates an asymmetrical light distribution. In some embodiments, between 55% and 90%, inclusive; between 60% and 85%, inclusive; 60% and 80%, inclusive; and/or 65% and 75%, inclusive of light emitted from the optic sheet 100 is directed in the desirable direction DD (with the remainder directed in the undesirable direction UD). However, the amount of light directed in the desirable direction versus the undesirable direction may be altered by adjusting the geometry of the TIR portions 112 and refactor portions 114 of the optic sheet 100.

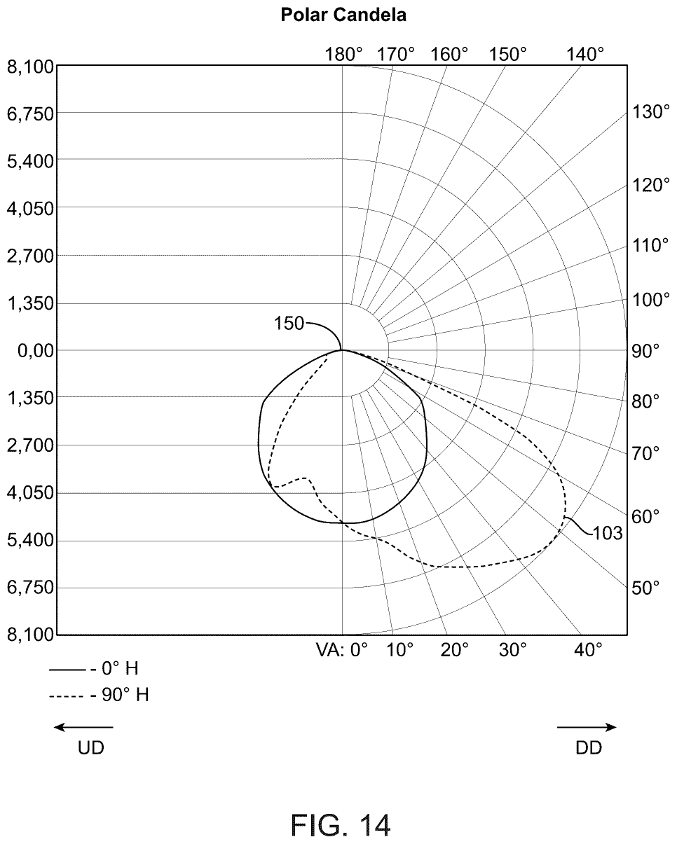

FIG. 14 is a polar plot of an intensity distribution created when light source(s) 150 emit light that is redirected by optic sheet 100. It is apparent that the optic sheet 100 directs the vast majority of emitted light 103 in the desirable direction DD. In this particular non-limiting embodiment, only approximately 30% of the emitted light 103 is directed in the undesirable direction UD, meaning that the vast majority of light (approximately 70%) is converted to forward light directed in the desirable direction DD toward the target area. Moreover, the optic 100 is able to control back lighting without the use of external shields or reflectors.

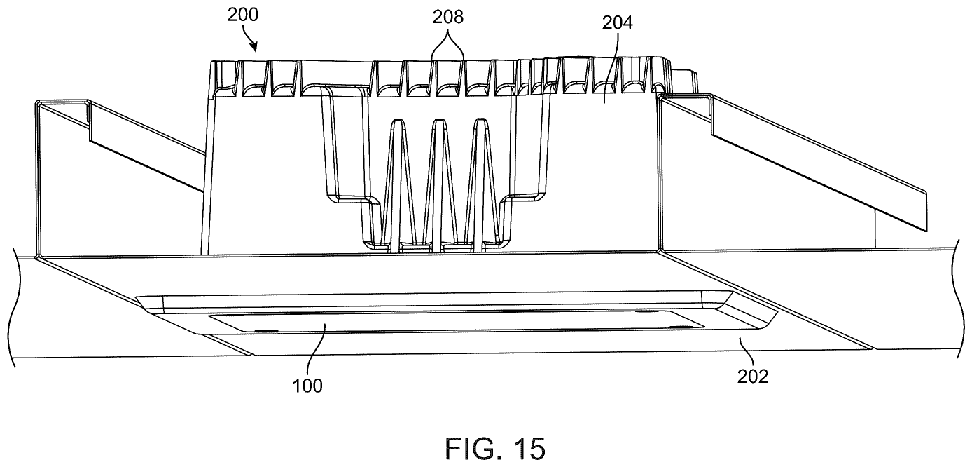

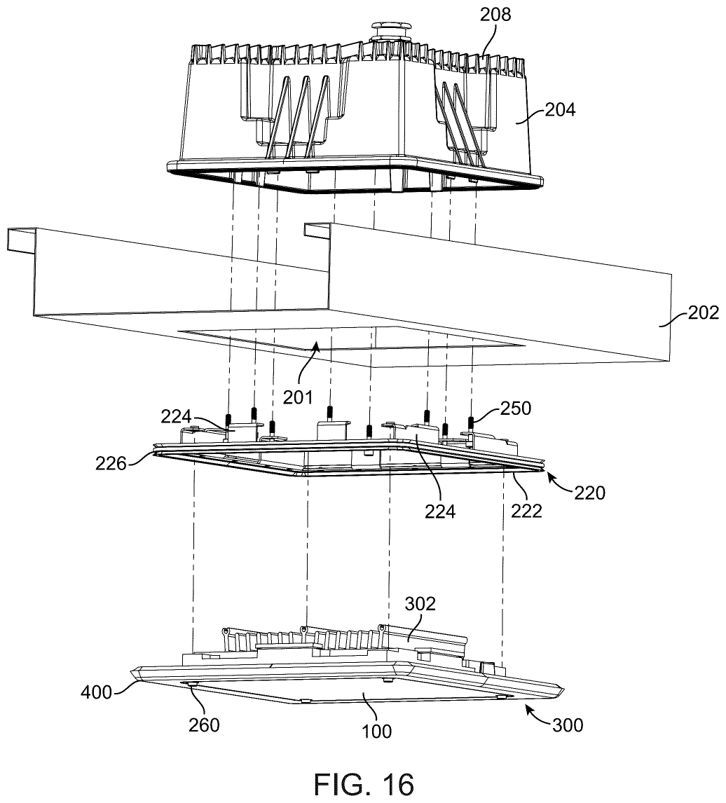

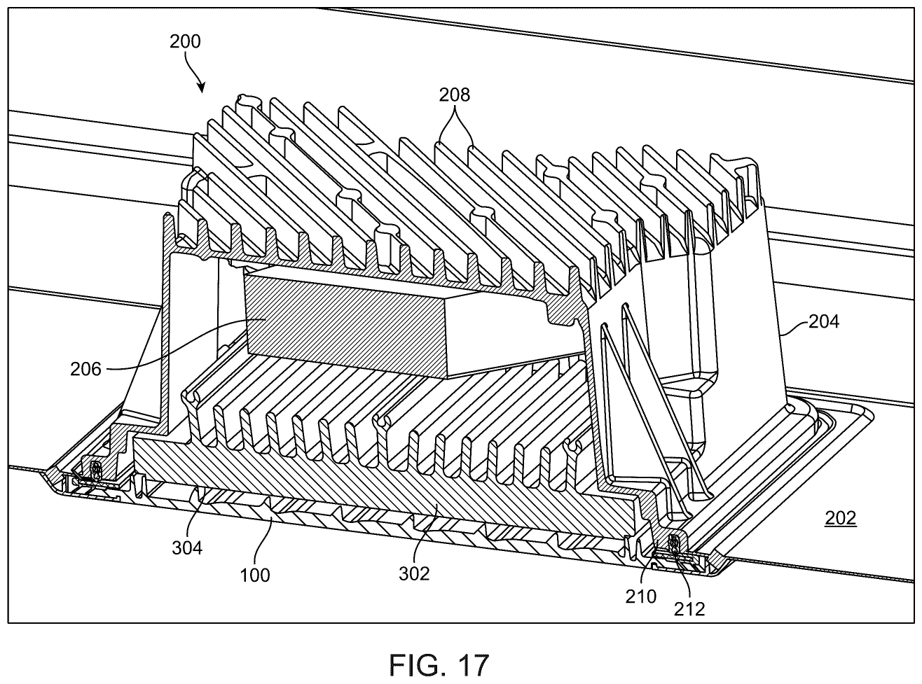

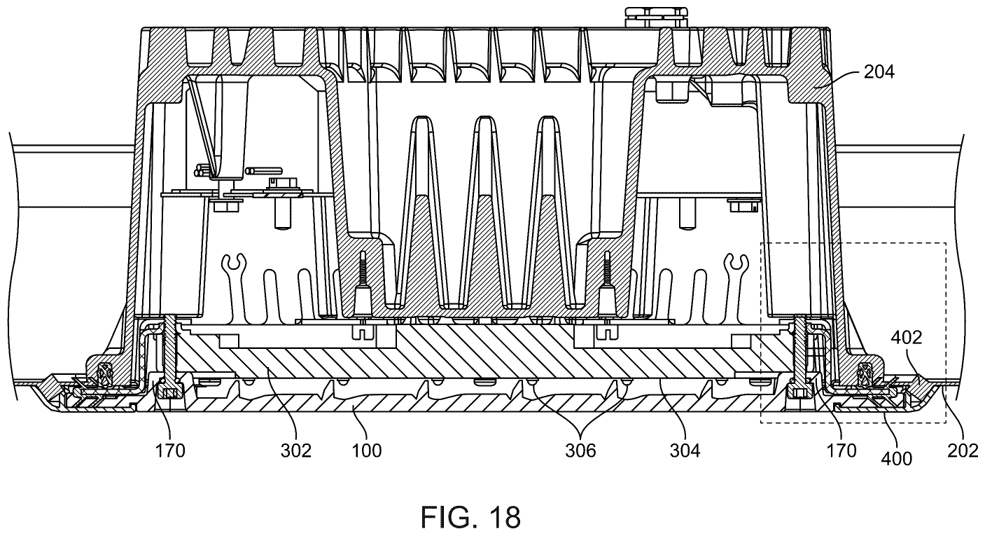

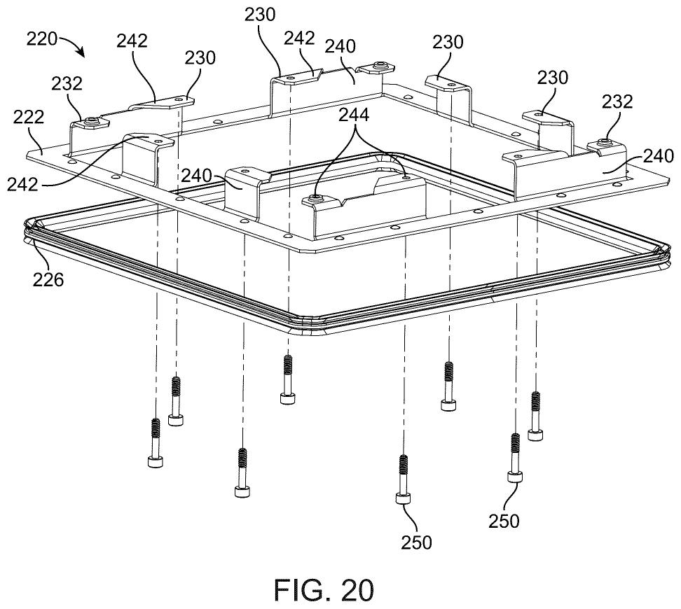

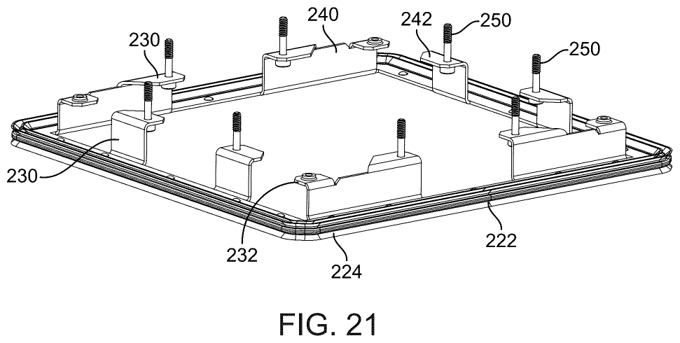

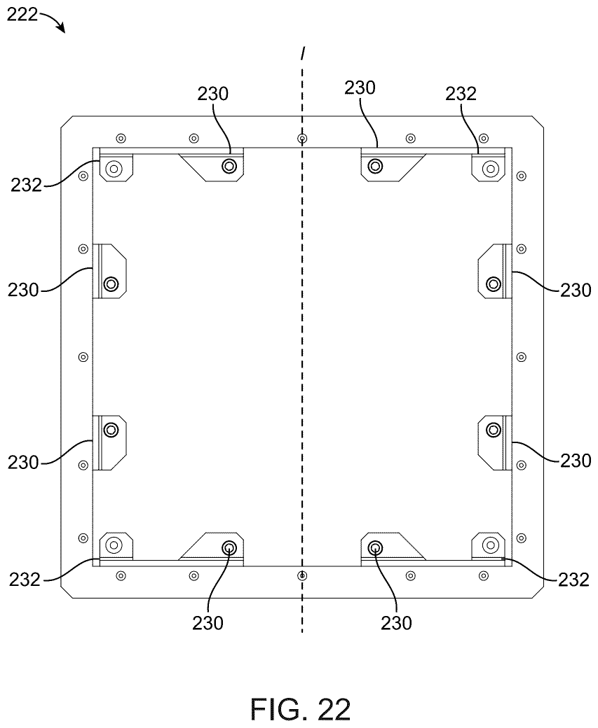

FIGS. 15-24 illustrate an embodiment of a light fixture 200 into which embodiments of the optic sheet 100 may be incorporated. However, it should be understood that embodiments of the optic sheet 100 may be incorporated into any light fixture where an asymmetrical distribution is desired, and the utility of the optic sheet is certainly not limited to use in the specific fixture disclosed herein. It should also be understood that embodiments of the light fixture disclosed herein may be used with optic sheets other than optic sheet 100, such as optic sheet 500.

In one specific, non-limiting embodiment, the light fixture 200 is positioned within a gas station canopy ceiling 202. The light fixture 200 generally includes an upper housing 204 that houses the fixture electronics 206 (e.g., drivers). The upper housing 204 may be formed of any material having suitable rigidity and thermal management properties. In some embodiments, the upper housing 204 is formed of metal, such as, but not limited to, steel, aluminum, etc. In some embodiments, the electronics 206 may be attached to (or housed within a compartment attached to) an inner surface of the upper housing 204 such that heat generated by the electronics 206 are transferred directly to the upper housing 204. In some embodiments, the upper housing 204 includes heat sink fins 208 on one or more external surfaces to dissipate heat generated by the electronics 206. Any geometry, number or arrangement of heat sink fins 208 may be provided on the upper housing.

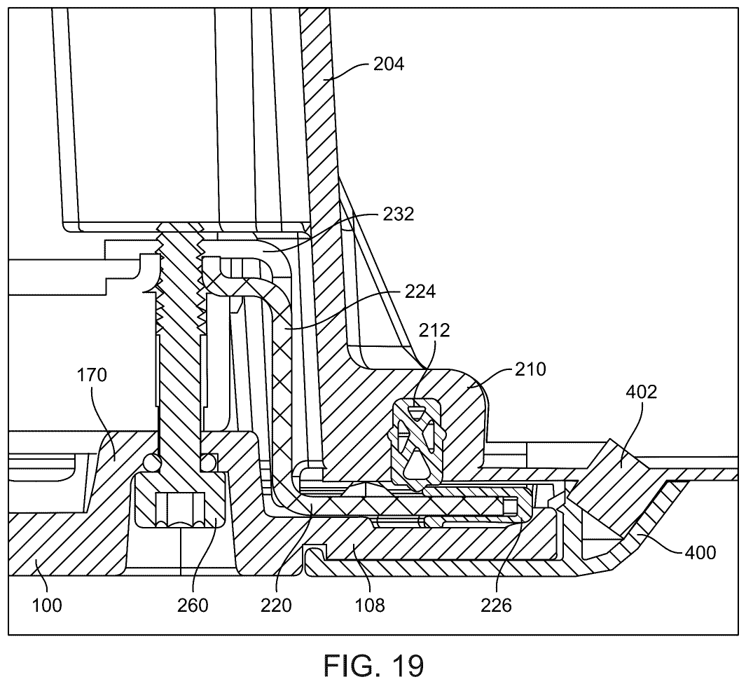

As shown in FIG. 19, in some embodiments one or more flanges 210 extend outwardly around the perimeter of the bottom of the upper housing 204. The one or more flanges 210 can house one or more upper housing gaskets 212. The one or more flanges 210 support the upper housing 204 above an opening 201 in the canopy ceiling 202, and the one or more upper housing gaskets 212 help to create a seal between the upper housing 204 and the canopy 202 to prevent the ingress of water, moisture, and other contaminants into the light fixture 200. For this reason, in some embodiments a flange 210 with associated upper housing gasket 212 extends around the entire perimeter of the upper housing 204 to form a complete seal with the canopy ceiling 202.

The light fixture 200 further includes a compression ring 220 comprising a base 222 that extends in a plane and that defines a central opening 222a. A plurality of arms 224 extend upwardly from the base 222. A compression ring gasket 226 may be provided around the periphery of the base 222 in some embodiments. The compression ring 220 may be formed of any material having suitable rigidity and thermal management properties. In some embodiments, the compression ring 220 is formed of metal, such as, but not limited to, steel, aluminum, etc.

In some embodiments, the plurality of arms 224 includes side arms 230 provided along the sides of the base 222. Two side arms 230 are provided along each side the base 222 in the illustrated embodiment. However, more or fewer side arms 230 may be provided. The plurality of arms 224 further includes a corner arm 232 proximate one or more corners of the base 222. A corner arm 232 is provided proximate each corner of the base 222 in the illustrated embodiment but need not be in all embodiments. In some embodiments, the compression ring 220 is reflectionally symmetrical about a line/that bisects the compression ring 220. In still other embodiments, the compression ring 220 is rotationally symmetrical in 90° rotational increments.

The plurality of arms 224 (side arms 230 and corner arms 232) include a first arm portion 240 that extends upwardly at an angle relative to the plane of the base 222 and a second arm portion 242 that extends inwardly from, and at an angle relative to, the axis of the first arm portion 240. An aperture 244 is provided in the second arm portion 242.

The compression ring 220 is attached to the upper housing 204 supported above the canopy ceiling 202. More specifically, the compression ring 220 is positioned below the canopy ceiling 202 with the plurality of arms 224 extending through the opening 201 in the canopy ceiling 202. Screws or other fasteners 250 are inserted upwardly through the apertures 244 in side arms 230 and engage bosses (not shown) provided in the upper housing 204. Tightening of the screws draws the compression ring towards the upper housing 204, thereby sandwiching the edge of the canopy ceiling 202 that defines the opening 201 between the upper housing flange 210 and the compression ring base 222. Upper housing gasket 212 bears against the upper surface of the canopy ceiling 202 and compression ring gasket 226 bears against the lower surface of the canopy ceiling 202 to prevent the ingress of water, moisture, and other contaminants into the light fixture 200.

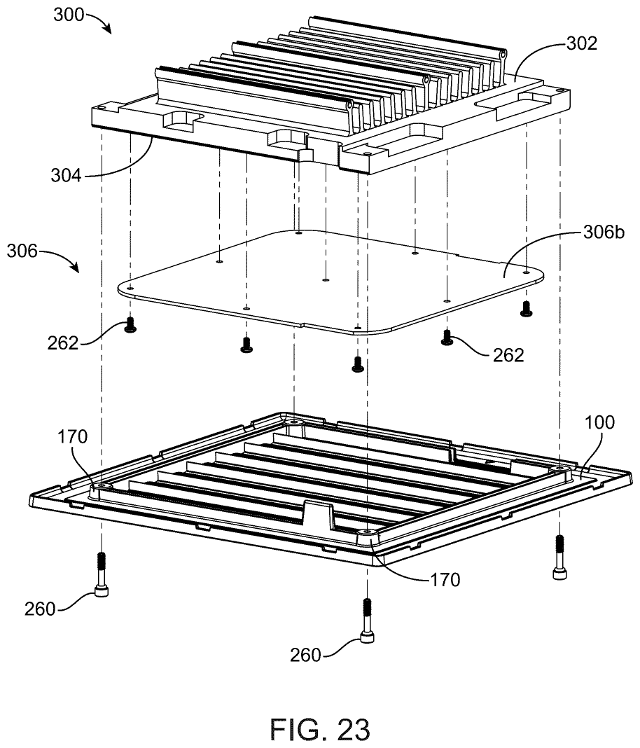

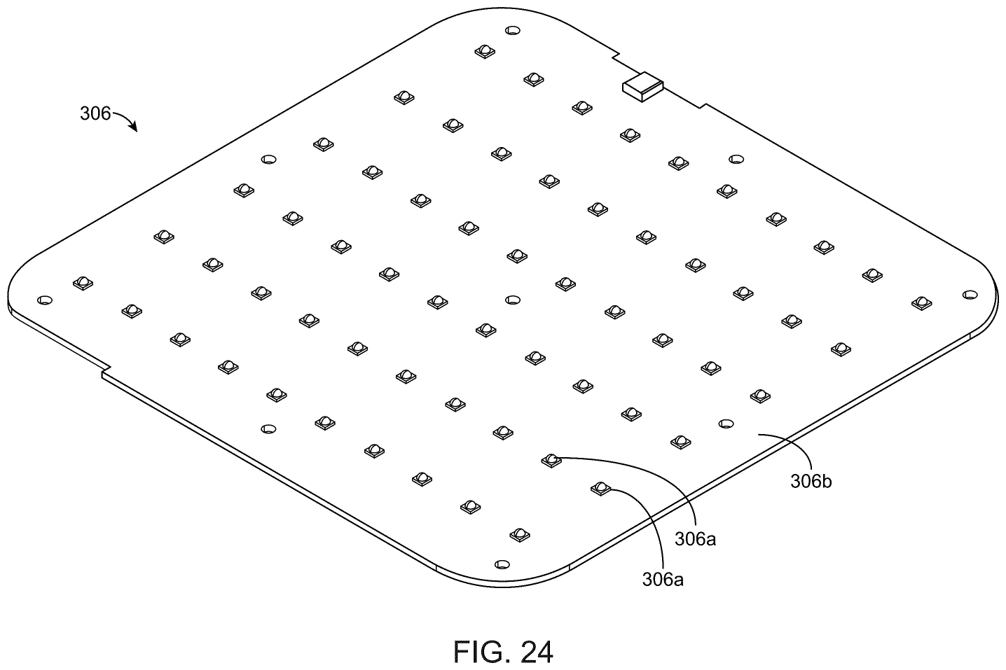

Light fixture 200 further includes a light emitting module 300 (see FIG. 23) that includes a finned heat sink 302 having an undersurface 304 onto which a plurality of light sources 306 (e.g., LEDs 306a mounted on a printed circuit board 306b, see FIG. 24) are attached (such as with fasteners 262). In some embodiments, the light sources 306 are provided in aligned rows across the undersurface 304 of the heat sink 302. Optic sheet 100 is provided below the light sources 306 to asymmetrically distributed the light emitted by the light sources 306 as discussed above. The optic sheet 100 includes bosses 170 that align with the corner arms 232 of the compression ring 220.

The light emitting module 300 is moved upwardly toward and partially through the central opening 222a of the base 222 and secured to the compression ring 220 with screws 260 that are inserted upwardly through the bosses 170 and apertures 244 of the corner arms 232. In this way, the light emitting module 300 may be removed from the light fixture 200 while the compression ring 220 and upper housing 204 remain in place within the installation. Thus, the directionality of the emitted light may be quickly altered via removal, rotation, and replacement of the light emitting module 300 without requiring removal and reinstallation of the light fixture 200 itself.

A bezel 400 may be provided around the perimeter of the light emitting module 300 to impart a polished appearance to the installation and can optionally support an elongated shield 402 that blocks any light from escaping through the sides of the light fixture 200 (i.e., prevent any uplight from the fixture).

While the light fixture 200 illustrated in FIGS. 15-24 has a substantially square profile, it may assume any shape suitable for a particular installation. Moreover, while the light fixture 200 is described having optic sheet 100, the optic/lens used in the light fixture is not so limited. Rather, any optic/lens may be used to achieve the desired distribution from the light fixture 200.

### EXAMPLES

A collection of exemplary embodiments, including at least some explicitly enumerated as “Examples” providing additional description of a variety of example types in accordance with the concepts described herein are provided below. These examples are not meant to be mutually exclusive, exhaustive, or restrictive; and the invention is not limited to these example examples but rather encompasses all possible modifications and variations within the scope of the issued claims and their equivalents.

Example 1. An optic sheet adapted to receive light and redirect at least some of the received light entering the optic sheet in a first direction such that the at least some received light exits the optic sheet in a second direction opposite the first direction, the optic sheet extending in a plane and comprising an optical area having a length, a width, a light entrance surface, a light exit surface, and a distance defined between the light entrance surface and the light exit surface, the optical area further comprising a plurality of first optic portions and a plurality of second optic portions provided in the light entrance surface and extending in rows across the width of the optical area and alternating along the length of the optical area, wherein: a. each of the plurality of first optic portions comprises an upstanding front wall and a curved back wall that curves convexly relative to the front wall and that comprises a total internal reflection surface, wherein the front wall is adapted to refract a first portion of received light traveling in the first direction towards the total internal reflection surface of the curved back wall and wherein the total internal reflection surface is adapted to reflect the first portion of received light in the second direction; b. each of the plurality of second optic portions comprises a first refractor portion and a second refractor portion, wherein the first refractor portion is interposed between the front wall of a first one of the plurality of first optic portions and the second refractor portion and wherein the second refractor portion is interposed between the first refractor portion and the curved back wall of a second one of the plurality of first optic portions, wherein the first refractor portion comprises a curved trough formed in the light entrance surface and wherein the second refractor portion comprises a substantially linear surface that extends at least partially between the first refractor portion and the second one of the plurality of first optic portions such that a thickness of the optical area at the second refractor portion is greater than the thickness of the optical area at the first refractor portion; and c. the optic sheet is adapted to emit more of the received light in the second direction than in the first direction.

Example 2. The optic sheet of any of the preceding or subsequent examples or combination of examples, wherein the optic sheet is adapted to emit between 60% and 85%, inclusive, of the received light in the second direction.

Example 3. The optic sheet of any of the preceding or subsequent examples or combination of examples, wherein the optic sheet is adapted to emit between 60% and 85% of the received light in the second direction and at an exit angle that is less than 80° relative to nadir.

Example 4. The optic sheet of any of the preceding or subsequent examples or combination of examples, wherein the optic sheet further comprises a mounting portion that extends around a perimeter of the optical area.

Example 5. The optic sheet of any of the preceding or subsequent examples or combination of examples, wherein the optic sheet comprises an upstanding barrier wall interposed between the optical area and the mounting portion.

Example 6. The optic sheet of any of the preceding or subsequent examples or combination of examples, wherein the light exit surface is substantially smooth.

Example 7. The optic sheet of any of the preceding or subsequent examples or combination of examples, wherein the plurality of first optic portions and the plurality of second optic portions extend in rows across the entire width of the optical area.

Example 8. The optic sheet of any of the preceding or subsequent examples or combination of examples, wherein the optical area comprises a first layer comprising the light entrance surface and a second layer comprising the light exit surface, wherein the first layer and the second layer comprise different materials.

Example 9. The optic sheet of any of the preceding or subsequent examples or combination of examples, wherein the first layer comprises silicone.

Example 10. The optic sheet of any of the preceding or subsequent examples or combination of examples, wherein the optical area further comprises a notch in the light entrance surface and wherein the notch is interposed between the second refractor portion and the curved back wall of the second one of the plurality of first optic portions.

Example 11. The optic sheet of any of the preceding or subsequent examples or combination of examples, wherein the second refractor portion is adapted to refract a second portion of received light traveling in the second direction that enters the second refractor portion at an entrance angle relative to nadir such that the second portion of received light exits the optic sheet at an exit angle relative to nadir that is less than the entrance angle.

Example 12. A light fixture comprising: a plurality of rows of light sources; and the optic sheet of any of the preceding or subsequent examples or combination of examples spaced a distance from, and positioned relative to, the plurality of rows of light sources such that the plurality of rows of lights sources emit light into the optical area of the optic sheet.

Example 13. The light fixture of any of the preceding or subsequent examples or combination of examples, wherein each of the plurality of rows of light sources extends directly above one of the plurality of second optic portions.

Example 14. The light fixture of any of the preceding or subsequent examples or combination of examples, further comprising an upper housing having a flange extending outwardly from the upper housing, wherein the flange is adapted to rest on an upper surface of a ceiling to suspend the upper housing above an opening in the ceiling.

Example 15. The light fixture of any of the preceding or subsequent examples or combination of examples, further comprising a gasket positioned on the flange and adapted to create a seal with the upper surface of the ceiling.

Example 16. The light fixture of any of the preceding or subsequent examples or combination of examples, further comprising a compression ring having a base with a central opening and a plurality of arms extending upwardly from the base, wherein the compression ring is adapted to mount to the upper housing via a first set of the plurality of arms such that the base of the compression ring is located below the ceiling.

Example 17. The light fixture of any of the preceding or subsequent examples or combination of examples, wherein the compression ring further comprises a gasket positioned on the base and adapted to create a seal with a lower surface of the ceiling when the compression ring is mounted to the upper housing.

Example 18. The light fixture of any of the preceding or subsequent examples or combination of examples, further comprising a light emitting module comprising a heat sink, the plurality of rows of light sources mounted on the heat sink, and the optic sheet, wherein the light emitting module is adapted to be at least partially received within the central opening of the base of the compression ring and mounted onto the compression ring via a second set of the plurality of arms.

Example 19. A light fixture comprising: an upper housing having a flange extending outwardly from the upper housing, wherein the flange is adapted to rest on an upper surface of a ceiling to suspend the upper housing above an opening in the ceiling; a compression ring having a base with a central opening and a plurality of arms extending upwardly from the base, wherein the compression ring is adapted to mount to the upper housing via a first set of the plurality of arms such that the base of the compression ring is located below the ceiling and the ceiling is sandwiched between the upper housing and the compression ring; and a light emitting module comprising: i. a heat sink; ii. a plurality of rows of light sources mounted on the heat sink; and iii. an optic sheet spaced a distance from, and positioned relative to, the plurality of rows of light sources such that the light entrance surface of the optical area of the optic sheet receives the light emitted by the plurality of rows of light sources, wherein the light exit surface of the optical area of the optic sheet is substantially smooth and wherein the light emitting module is adapted to be at least partially received within the central opening of the base of the compression ring and mounted onto the compression ring via a second set of the plurality of arms.

Example 20. The light fixture of any of the preceding or subsequent examples or combination of examples, wherein between 60% and 85%, inclusive, of the received light emitted by the plurality of rows of light sources exits the light fixture in the second direction.

Example 21. The light fixture of any of the preceding or subsequent examples or combination of examples, wherein the optic sheet comprises the optic sheet of any of the preceding or subsequent examples or combination of examples.

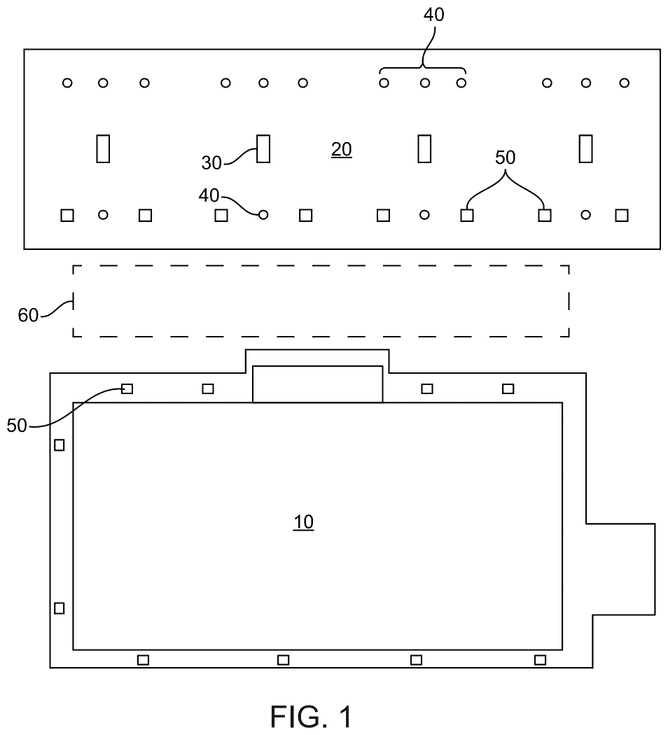

The various aspects, embodiments, implementations or features of the described embodiments can be used separately or in any combination. In particular, it should be appreciated that the various elements of concepts from FIGS. 1-24 may be combined without departing from the spirit or scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. An optic sheet adapted to receive light and redirect at least some of the received light entering the optic sheet in a first direction such that the at least some of the received light exits the optic sheet in a second direction opposite the first direction, the optic sheet extending in a plane and comprising an optical area having a length, a width, a light entrance surface, a light exit surface, and a distance defined between the light entrance surface and the light exit surface, the optical area further comprising a plurality of first optic portions and a plurality of second optic portions provided in the light entrance surface and extending in rows across the width of the optical area and alternating along the length of the optical area, wherein:
a. each of the plurality of first optic portions comprises an upstanding front wall and a curved back wall that curves convexly relative to the front wall and that comprises a total internal reflection surface, wherein the front wall is adapted to refract a first portion of received light traveling in the first direction towards the total internal reflection surface of the curved back wall and wherein the total internal reflection surface is adapted to reflect the first portion of received light in the second direction;
b. each of the plurality of second optic portions comprises a first refractor portion and a second refractor portion, wherein the first refractor portion is interposed between the front wall of a first one of the plurality of first optic portions and the second refractor portion and wherein the second refractor portion is interposed between the first refractor portion and the curved back wall of a second one of the plurality of first optic portions, wherein the first refractor portion comprises a curved trough formed in the light entrance surface and wherein the second refractor portion comprises a substantially linear surface that extends at least partially between the first refractor portion and the second one of the plurality of first optic portions such that a thickness of the optical area at the second refractor portion is greater than the thickness of the optical area at the first refractor portion; and
c. the optic sheet is adapted to emit more of the received light in the second direction than in the first direction.

2. The optic sheet of claim 1, wherein the optic sheet is adapted to emit between 60% and 85%, inclusive, of the received light in the second direction.

3. The optic sheet of claim 2, wherein the optic sheet is adapted to emit between 60% and 85% of the received light in the second direction and at an exit angle that is less than 80° relative to nadir.

4. The optic sheet of claim 1, wherein the optic sheet further comprises a mounting portion that extends around a perimeter of the optical area.

5. The optic sheet of claim 4, wherein the optic sheet comprises an upstanding barrier wall interposed between the optical area and the mounting portion.

6. The optic sheet of claim 1, wherein the light exit surface is substantially smooth.

7. The optic sheet of claim 1, wherein the plurality of first optic portions and the plurality of second optic portions extend in rows across the entire width of the optical area.

8. The optic sheet of claim 1, wherein the optical area comprises a first layer comprising the light entrance surface and a second layer comprising the light exit surface, wherein the first layer and the second layer comprise different materials.

9. The optic sheet of claim 8, wherein the first layer comprises silicone.

10. The optic sheet of claim 1, wherein the optical area further comprises a notch in the light entrance surface and wherein the notch is interposed between the second refractor portion and the curved back wall of the second one of the plurality of first optic portions.

11. The optic sheet of claim 1, wherein the second refractor portion is adapted to refract a second portion of received light traveling in the second direction that enters the second refractor portion at an entrance angle relative to nadir such that the second portion of received light exits the optic sheet at an exit angle relative to nadir that is less than the entrance angle.

12. A light fixture comprising:
a. a plurality of rows of light sources; and
b. the optic sheet of claim 1 spaced a distance from, and positioned relative to, the plurality of rows of light sources such that the plurality of rows of lights sources emit light into the optical area of the optic sheet.

13. The light fixture of claim 12, wherein each of the plurality of rows of light sources extends directly above one of the plurality of second optic portions.

14. The light fixture of claim 12, further comprising an upper housing having a flange extending outwardly from the upper housing, wherein the flange is adapted to rest on an upper surface of a ceiling to suspend the upper housing above an opening in the ceiling.

15. The light fixture of claim 14, further comprising a gasket positioned on the flange and adapted to create a seal with the upper surface of the ceiling.

16. The light fixture of claim 14, further comprising a compression ring having a base with a central opening and a plurality of arms extending upwardly from the base, wherein the compression ring is adapted to mount to the upper housing via a first set of the plurality of arms such that the base of the compression ring is located below the ceiling.

17. The light fixture of claim 16, wherein the compression ring further comprises a gasket positioned on the base and adapted to create a seal with a lower surface of the ceiling when the compression ring is mounted to the upper housing.

18. The light fixture of claim 16, further comprising a light emitting module comprising a heat sink, the plurality of rows of light sources mounted on the heat sink, and the optic sheet, wherein the light emitting module is adapted to be at least partially received within the central opening of the base of the compression ring and mounted onto the compression ring via a second set of the plurality of arms.

19. A light fixture comprising:
a. an upper housing having a flange extending outwardly from the upper housing, wherein the flange is adapted to rest on an upper surface of a ceiling to suspend the upper housing above an opening in the ceiling;
b. a compression ring having a base with a central opening and a plurality of arms extending upwardly from the base, wherein the compression ring is adapted to mount to the upper housing via a first set of the plurality of arms such that the base of the compression ring is located below the ceiling and the ceiling is sandwiched between the upper housing and the compression ring; and
c. a light emitting module comprising:
i. a heat sink;
ii. a plurality of rows of light sources mounted on the heat sink and adapted to emit light; and
iii. an optic sheet extending in a plane and comprising an optical area having a light entrance surface and a light exit surface, wherein the optic sheet is spaced a distance from, and positioned relative to, the plurality of rows of light sources such that the light entrance surface of the optical area of the optic sheet receives the light emitted by the plurality of rows of light sources,
wherein the light exit surface of the optical area of the optic sheet is substantially smooth and wherein the light emitting module is adapted to be at least partially received within the central opening of the base of the compression ring and mounted onto the compression ring via a second set of the plurality of arms.

20. The light fixture of claim 19, wherein the optic sheet is adapted to redirect at least some of the received light entering the light entrance surface of the optical area in a first direction such that the at least some of the received light exits the optic sheet in a second direction opposite the first direction, the optical area having a length, a width, and a distance defined between the light entrance surface and the light exit surface, the optical area further comprising a plurality of first optic portions and a plurality of second optic portions provided in the light entrance surface and extending in rows across the width of the optical area and alternating along the length of the optical area, wherein:
each of the plurality of first optic portions comprises an upstanding front wall and a curved back wall that curves convexly relative to the front wall and that comprises a total internal reflection surface, wherein the front wall is adapted to refract a first portion of received light traveling in the first direction towards the total internal reflection surface of the curved back wall and wherein the total internal reflection surface is adapted to reflect the first portion of received light in the second direction;
each of the plurality of second optic portions comprises a first refractor portion and a second refractor portion, wherein the first refractor portion is interposed between the front wall of a first one of the plurality of first optic portions and the second refractor portion and wherein the second refractor portion is interposed between the first refractor portion and the curved back wall of a second one of the plurality of first optic portions, wherein the first refractor portion comprises a curved trough formed in the light entrance surface and wherein the second refractor portion comprises a substantially linear surface that extends at least partially between the first refractor portion and the second one of the plurality of first optic portions such that a thickness of the optical area at the second refractor portion is greater than the thickness of the optical area at the first refractor portion; and
the optic sheet is adapted to emit more of the received light in the second direction than in the first direction.
